(19) United States
(12) Patent Application Publication
(10) Pub. No.: US 2011/0134944 A1
(43) Pub. Date: Jun. 9, 2011

(54) EFFICIENT PULSE LASER LIGHT GENERATION AND DEVICES USING THE SAME

(75) Inventors: Yushi Kaneda, Tucson, AZ (US); Jun Sakuma, Yokohama (JP)

(73) Assignees: The Arizona Board of Regents on behalf of The University of Arizona, Tucson, AZ (US); Lasertec Corporation, Yokohama (JP)

(21) Appl. No.: 12/633,658

(22) Filed: Dec. 8, 2009

(51) Int. Cl. H01S 3/109; H01S 3/10

(52) U.S. Cl. 372/22

(57) ABSTRACT

A time delay is introduced in the optical path of the light pulse at fundamental wavelength relative to that for the fourth harmonic light pulse in a set up for generating the 5^{th} harmonic, to compensate for at least a portion of the time delay of the fourth harmonic relative to the fundamental wavelength caused by 4HG generation. In one embodiment, this is achieved by introducing a time delay of the fundamental relative to the second harmonic wavelength, such as preferably by means of a timing compensator in the optical paths of the second harmonic and the fundamental wavelength. Preferably, any further delay of the fourth harmonic relative to the fundamental wavelength caused by other optical components can also be compensated for in this manner.

### BACKGROUND OF THE INVENTION

This invention relates in general to laser light generation, and in particular to efficient pulse laser light generation of higher harmonics from light at a fundamental wavelength.

For many optical instruments, it is important to use light of the desired wavelengths, such as in telecommunication, and in semiconductor equipment. In recent years, the generation of light at smaller wavelengths, such as ultraviolet light, is desirable for different types of semiconductor equipment. For example, in order to reduce the size of transistors in semiconductors, it is desirable to use light of smaller wavelengths to improve resolution in photolithography. For discovering tiny defects in semiconductor devices during or after manufacture, it is desirable to use light of smaller wavelengths to improve resolution in anomaly detection.

One common technique for generating light at smaller wavelengths is to pass light from a light source such as a laser through a non-linear crystal, which combines photons from the laser to form higher harmonics photons of higher energy, and hence smaller wavelengths. One such scheme generates light of the fifth harmonic (Fifth Harmonic Generation or 5HG). In this application, “HG” stands for “Harmonic Generation.”

In a typical 5HG setup, 3 crystals are set up in line, with perhaps some focusing optics in between, as shown in FIG. 1. As shown in FIG. 1, a laser source (not shown) supplies a light pulse 12 at fundamental wavelength of 1064 nm to the Second Harmonic Generation crystal (SHG) 14. The vertical double-sided arrow 12′ illustrates that the polarization of the pulse 12 supplied by the laser source is in the plane of the paper. SHG 14 passes light pulse 12 at fundamental wavelength of 1064 nm without changing its polarization and generates a second harmonic light pulse 16 at 532 nm with polarization 16′ orthogonal to the plane of the paper, as illustrated by the arrow pointing out of the paper. The relative temporal positions of the pulses 12 and 16 after SHG 14 are also illustrated by the positions of arrows 12′ and 16′ in their respective optical paths in FIG. 1. SHG 14 introduces only a small time delay to second harmonic light pulse 16 at 532 nm relative to the light pulse 12 at fundamental wavelength passed by crystal 14, and the relative temporal positions of the two pulses outputted by crystal 14 are as illustrated by the points at the arrows 12′ and 16′ in FIG. 1. The same convention as noted above for pulses 12 and 16 is used in all of the figures of this application to illustrate polarization states and the relative temporal positions of the pulses in their respective optical paths. The Fourth Harmonic Generation or 4HG crystal 20, however, introduces a significant time delay to fourth harmonic light pulse 22 at 266 nm relative to the light pulse 24 at fundamental wavelength passed by crystal 20, and the polarizations and relative positions 22′ and 24′ of the two pulses outputted by crystal 20 are illustrated in FIG. 1. The second harmonic light pulse at 532 nm also passed by crystal 20 may be sent to a beam dump (not shown). Thus when the light pulses 22 and 24 reach the 5HG crystal 26, they may overlap for only a short time period, or no longer overlap at all, so that the fifth harmonic pulse 28 at 213 nm is diminished in intensity or fails to be generated at all.

In conventional schemes, the time delay to fourth harmonic light pulse 22 at 266 nm relative to the light pulse 24 at fundamental wavelength passed by crystal 20 is compensated by means of mirrors 32 to alter the relative optical path lengths experienced by the two pulses, as shown in FIG. 2, illustrating another conventional setup. However, the set up of FIG. 2 is complicated and bulky. It is therefore desirable to provide an improved optical design whereby the above disadvantages of prior designs are avoided.

### SUMMARY

The problem above of the time delay of the fourth harmonic relative to the fundamental wavelength can be solved by introducing a time delay in the optical path of the light pulse at fundamental wavelength relative to that for the fourth harmonic light pulse, to compensate for at least a portion of the above explained time delay of the fourth harmonic relative to the fundamental wavelength. In one embodiment, this is achieved by introducing a time delay of the second harmonic relative to the fundamental wavelength, such as preferably by means of a timing compensator in the optical paths of the second harmonic and the fundamental wavelength. Preferably, any further delay of the fourth harmonic relative to the fundamental wavelength caused by other optical components can also be compensated for in this manner.

In one implementation of the embodiment mentioned above, a laser light generating apparatus comprises a laser source emitting optical pulses at a fundamental wavelength λ₁, and a first nonlinear crystal receiving the optical pulses at fundamental λ₁ and generates second harmonic optical pulses at wavelength λ₂, where λ₂ is substantially equal to half of λ₁. A second nonlinear crystal receives the optical pulses at wavelengths λ1 and λ2 and generates fourth harmonic optical pulses at wavelength λ₄ where λ₄ is substantially equal to half of λ₂. The first and second nonlinear crystals cause a time delay of the optical pulses at wavelength λ₄ relative to the optical pulses at wavelength λ₁. A third nonlinear crystal receives the optical pulses at wavelengths λ₁ and λ₄ and generates a fifth harmonic pulse λ₅ where frequency of the fifth harmonic pulse λ₅ is substantially equal to the sum of the frequencies of the optical pulses at wavelengths λ₁ and λ₄. A birefringent crystal is placed between the first and second nonlinear crystals and receives the optical pulses at wavelengths λ₁ and λ₂, wherein the optical pulses at wavelength λ₁ travel at a slower speed in the birefringent crystal than the optical pulses at wavelength λ₂, to compensate for at least a portion of the time delay between the optical pulses at wavelength λ₄ relative to the optical pulses at wavelength λ₁.

In another implementation of the embodiment mentioned above, a method for higher harmonic light generation comprises supplying optical pulses at a fundamental wavelength λ₁ to a first nonlinear crystal so that the first nonlinear crystal generates second harmonic optical pulses at wavelength λ₂, where λ₂ is substantially equal to half of λ₁; supplying the optical pulses at wavelengths λ₁ and λ₂ to a second nonlinear crystal so that the second nonlinear crystal generates fourth harmonic optical pulses at wavelength λ₄ where λ₄ is substantially equal to half of λ₂. The first and second nonlinear crystals cause a first time delay of the optical pulses at wavelengths λ₄ relative to the optical pulses at wavelengths λ₁. A second time delay of the optical pulses at wavelengths λ₁ relative to the optical pulses at wavelength λ₂ is caused before the optical pulses at wavelengths λ₁ and λ₂ reach the second nonlinear crystal, so that the second time delay compensates for at least a part of and reduces the first time delay.

The above technique may be used for supplying light to a sample, such as in the case of photolithography or defect inspection in the semiconductor industry.

### BRIEF DESCRIPTION OF THE DRAWINGS

FIG. 1 is a schematic view of a conventional “in-line” 5^{th} harmonic generation setup.

FIG. 2 is a schematic view of a conventional “split-and-combine” 5^{th} harmonic generation setup.

FIG. 3 is a schematic view to illustrate the effect of the time delay of the higher order harmonics relative to the pulse at fundamental wavelength to illustrate the operation of a realistic implementation of the conventional “in-line” 5^{th} harmonic generation setup of FIG. 1.

FIG. 4 is a schematic view of an “In-line” 5HG configuration with timing slip-off compensation to illustrate the concept of an embodiment of the invention.

FIG. 5 is a schematic view of an in-line 5^{th} harmonic generation setup with timing compensation to illustrate an implementation of the configuration of FIG. 4.

FIG. 6 is a schematic view of an in-line 5^{th} harmonic generation setup with timing compensation to illustrate another implementation of the configuration of FIG. 4.

FIG. 7 is a schematic view of an optical instrument for supplying light to a sample using an in-line 5^{th} harmonic generation setup with timing compensation.

For convenience in description, identical components are labeled by the same numbers in this application.

### DETAILED DESCRIPTION

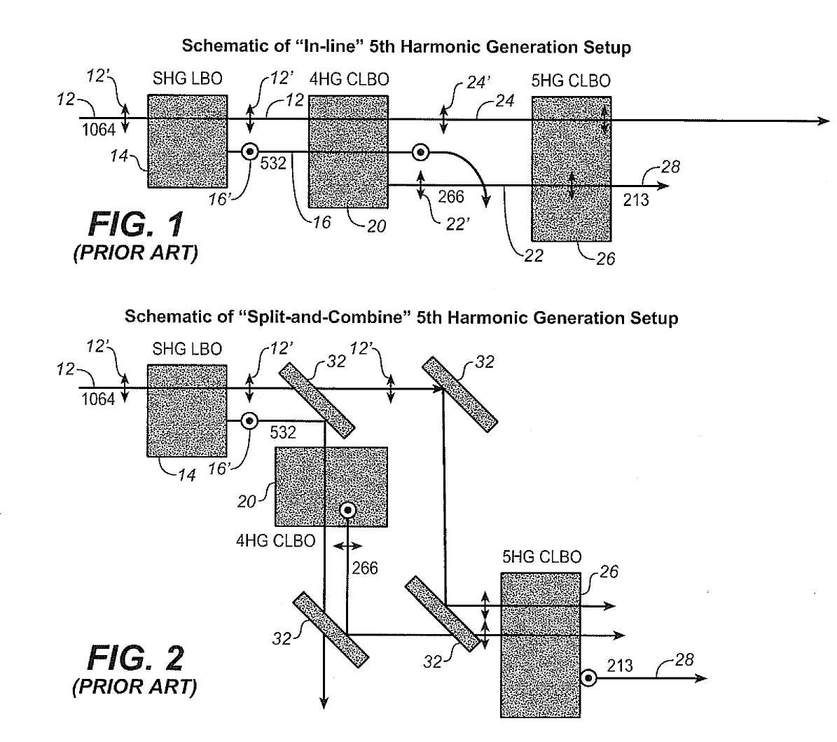

A significant advantage of the “in-line” configuration of FIG. 1 is the simplicity, as opposed to another conventional setup shown in FIG. 2. As explained above and depicted in FIG. 1, the fundamental and 4^{th} harmonic pulses do not meet in the 5HG crystal 26. The typical length of the crystals is of the order of centimeters, and the total thickness of the lenses used in the optical set up is also of the order of centimeters, and usually fused silica is used as the material. The group indices, which dictate the arrival time of the pulse at each wavelength, are listed in Table 1 below. As the group index is always smaller for the pulse at fundamental wavelength, the pulse at fundamental always advance with respect to other pulses.

TABLE 1
Group indices of material used

| | | | Index |
|---|---|---|---|
| | Group | | difference from |
| | Index | | fundamental |
| CLBO 4HG (9 = 62 deg.) | | | |
| Fundamental (1064 nm) | 1.45568 | e~ray | |
| 2nd harmonic (532 nm) | 1.47994 | o~ray | Δn₂ = 0.06977 |
| 4th harmonic (266 nm) | 1.62414 | e-ray | Δn₄ = 0.16846 |
| CLBO 5HG (( ) = 68.4 deg.) | | | |
| Fundamental (1064 nm) | 1.49911 | o-ray | |
| 4th harmonic (266 nm) | 1.69037 | o-ray | Δn₅ = 0.19126 |
| fused silica | | | |
| Fundamental (1064 nm) | 1.4624 | o-ray | |
| 4th harmonic (532 nm) | 1.48534 | o-ray | Δns₂ = 0.0229 |
| 4th harmonic (266 nm) | 1.61468 | | Δns₄ = 0.15228 |

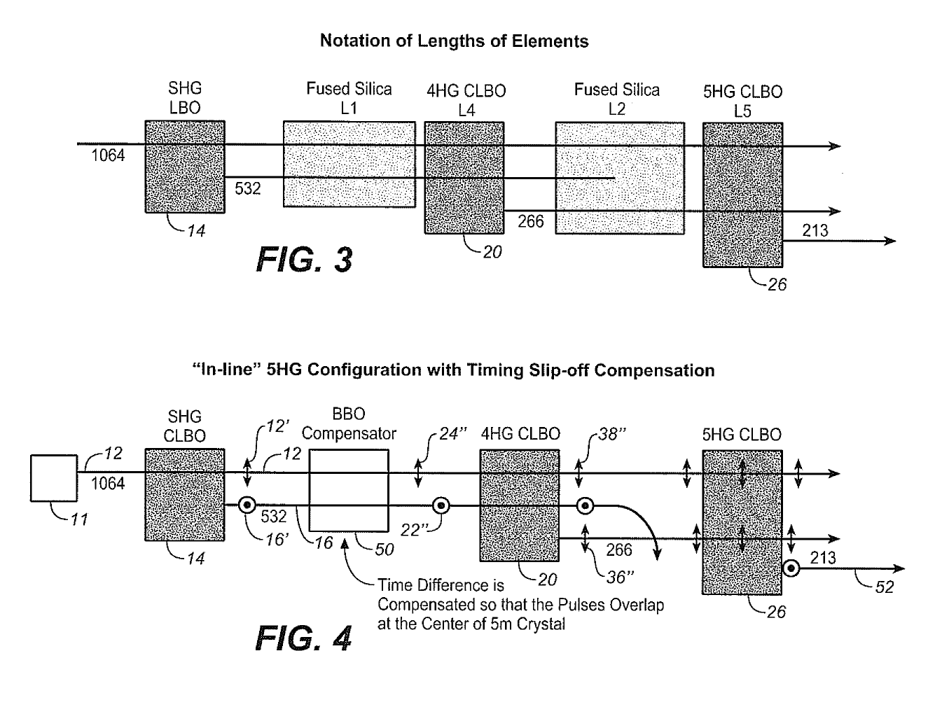

CLBO in the table above stands for cesium lithium borate CsLiB₆O₁₀. We shall now estimate the difference in time of arrival of the light pulses at fundamental and 4^{th} harmonic at the center of the 5HG crystal, in reference to FIG. 3. For the sake of argument, we shall ignore the dispersion of air, but can be taken into account later if necessary.

As depicted in FIG. 3, L1, L2 represents the total thickness of the fused silica (glass) between SHG&4HG crystals 14 and 20 and that between 4HG&5HG crystals 20 and 26. They are the total sum of the thickness of the optics in the range, such as lenses or windows. L4 and L5 are the lengths of the 4HG crystal 20 and 5HG crystal 26.

We shall ignore the group velocity dispersion in the SHG crystal, as it is small, (Group velocity difference about 0.01.) Now, as the pulses enters the fused silica of length L1, the pulses at fundamental and 2^{nd} harmonic are synchronous. Because of the difference in group velocity, at the exit of L1-long fused silica, and hence at the entrance of 4HG crystal, the time of arrival of the pulses are different by Δns₂L1/c. (Where c is the speed of light in vacuum.)

Likewise, at the center of 4HG crystal, they are different by Δn₂L4/(2 c).

From the center of 4HG crystal, we shall consider the difference in time of arrival between the fundamental and the 4th harmonic. From the center of 4HG crystal to the exit face of 4HG crystal, the difference is Δn₄L4/(2 c), the delay caused by the L2-long fused silica is Δns₄L2/c, and the 5HG center from the entrance to the center is Δn₅L5/(2 c).

$$They add up to Δ t = \frac{1}{c} ( L 1 {Δ ns}_{2} + L 2 {Δ ns}_{4} + \frac{L 4}{2} ( Δ {n}_{2} + Δ {n}_{4} ) + \frac{L 5}{2} Δ {n}_{5} ) .$$

If we take an example of typical values, L1=L2=10 mm, L4=15 mm, and L5=10 mm, the total delay is approximately 15 ps. If the pulsewidth is of the order of 10 ps, such delay would be more than sufficient to completely displace the fundamental pulses from the 4^{th} harmonic, making the 5HG impractical.

The present invention alleviates this problem, without having to split the beam paths between the fundamental and 4^{th} harmonic in the configuration shown in FIG. 4, thus keeping the system simple. The inventors have identified a material in which the pulse at the fundamental travels at a slower speed than the second harmonic pulse. In one embodiment, this material includes barium borate BBO. As illustrated in FIG. 4, a BBO compensator 50 causes a delay of the pulse 12 from laser 11 at the fundamental (1064 nm) at position 24″ relative to the second harmonic pulse (532 nm) at position 22″, where the relative positions of the two pulses are as shown in FIG. 4. The 4HG CLBO 20 introduces a delay to the 4^{th} harmonic (266 nm) pulse at position 36″ relative to the pulse at fundamental (1064 nm) at position 38″ upon exiting the 4HG CLBO 20 as shown in FIG. 4. However, due to the effect of the BBO compensator 50, the 4^{th} harmonic (266 nm) pulse still arrives at the 5HG CLBO 26 earlier than the pulse at fundamental (1064 nm). The pulse at fundamental (1064 nm) finally catches up with the 4^{th} harmonic (266 nm) pulse upon reaching the center of the 5HG CLBO 26, so that the fundamental and the 4th harmonic (266 nm) pulses overlap fully within the 5HG CLBO 26, to generate the 5^{th} harmonic pulse 52 at 213 nm. The frequency of the 5^{th} harmonic pulse 52 is substantially the sum of the frequencies of the pulse at fundamental and of the second harmonic pulse.

Barium borate, a negative uniaxial crystal, either α- or β-phase, has the property needed for the application of the present invention. Owing to large birefringence, barium borate has the group indices summarized in Table 2. Laser 11 may be a modelocked Nd:YAG or modelocked Nd:YVO₄ laser.

TABLE 2
Group indices of BBO

| | Group | | Index difference from |
|---|---|---|---|
| BBO (⊖ = 90 deg.) | index | | fundamental |
| Fundamental | 1.67387 | o-ray | |
| 2nd harmonic | 1.58883 | e--ray | Δnc₂ = −0.08504 |
| 4th harmonic | 1.79684 | e--ray | Δnc₄ = 0.12297 |

As evidently seen in Table 2, the only combination that allows delaying fundamental relative to harmonics is to have the fundamental wavelength in o-ray and the 2^{nd} harmonic in e-ray to delay the fundamental with respect to the second harmonic. In order to compensate the 15-ps time difference, the thickness of the material needed is Δt c/Δnc₂=52.9 mm. Thus, the above combination as an implementation of the scheme of FIG. 4 will ensure that optical pulses with short durations (such as durations shorter than 100 ps) will overlap in the 4HG for generating the 5^{th} harmonic.

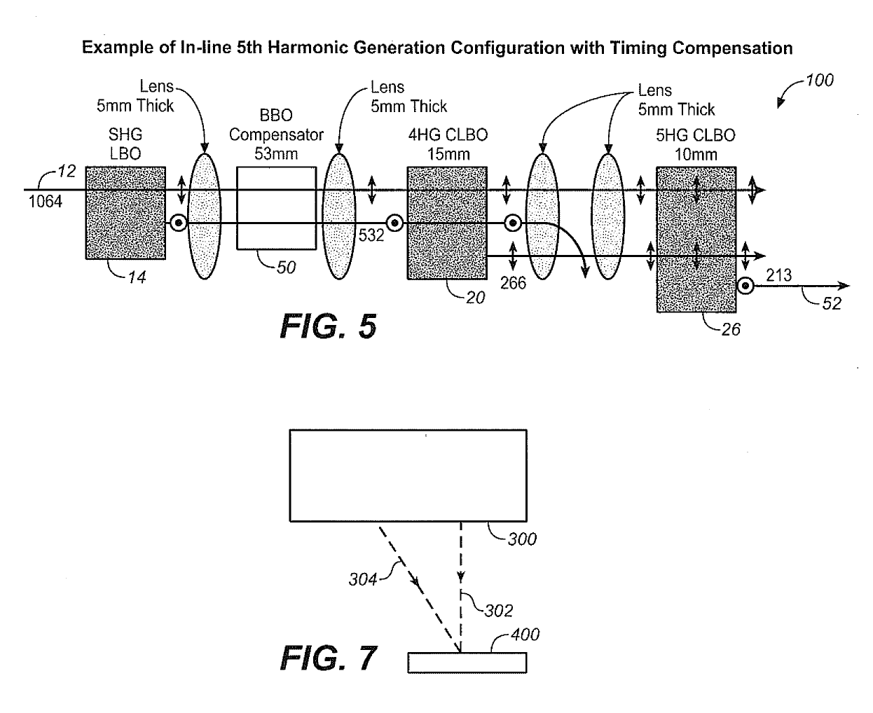

FIG. 5 is a schematic view of an in-line 5^{th} harmonic generation setup 100 with timing compensation to illustrate an implementation of the configuration of FIG. 4, including the lenses that focus the rays to the elements 14, 50, 20 and 26.

The lenses that focus the rays to the elements 14, 50, 20 and 26 also cause the 4^{th} harmonic pulses to be delayed relative to the pulses at fundamental wavelength. This time delay may be taken into account in choosing the design and thickness of the material in compensator 50. Therefore the configuration as in FIG. 5 would properly compensate for the difference in time of arrival of the pulses at fundamental and 4^{th} harmonic, including that caused by the relative time delay between the fundamental and the 4^{th} harmonic caused by the lenses, and hence allows efficient generation of 5^{th} harmonic.

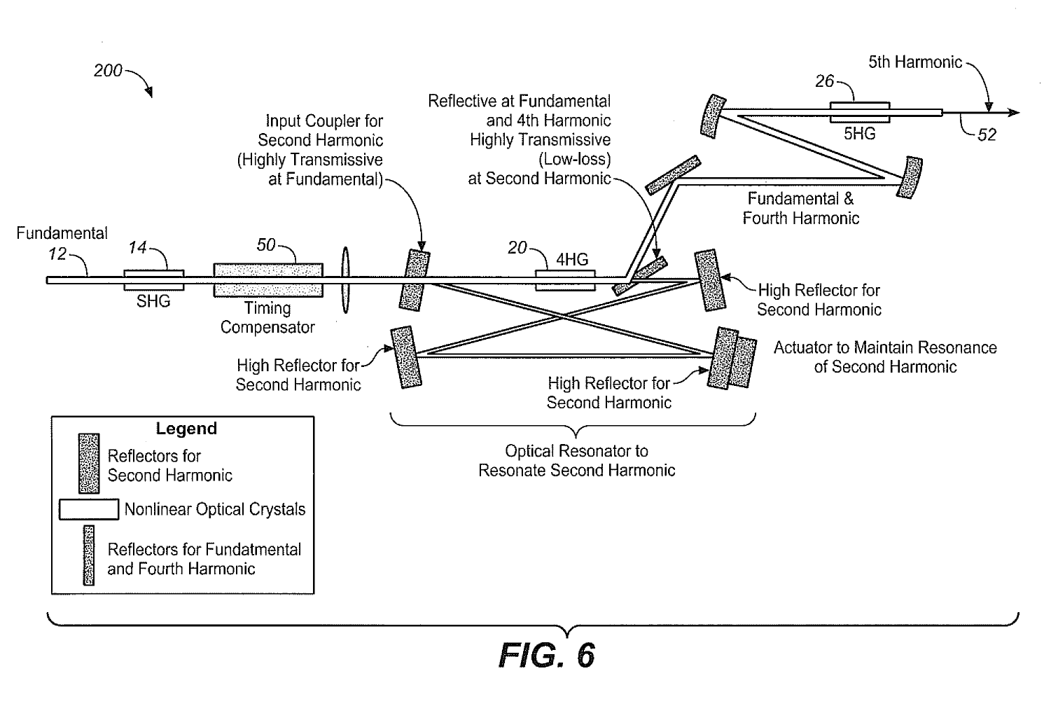

FIG. 6 is a schematic view of an in-line 5^{th} harmonic generation setup 200 with timing compensation to illustrate another implementation of the configuration of FIG. 4. The optical set up in FIG. 6 includes a lens for focusing towards the 4HG 20, an optical resonator for resonating the second harmonic together with an actuator for maintaining resonance of second harmonic and other mirrors for reflecting the pulses at fundamental and 4^{th} harmonic wavelengths to the 5HG 26. A technique for efficient frequency doubling of a modelocked laser using an optical resonator is described in the article “High-power second-harmonic generation with picosecond and hundreds-of-picosecond pulses of a cw mode-locked Ti:sapphire laser,” M. Watanabe, R. Ohmukai, K. Hayasaka, H. Imajo, and S. Urabe, Optics Letters 19, 637-639 (1994). This reference is incorporated herein by reference in its entirety so that the technique need not be described in detail here. The setup in this article is adapted for use in FIG. 6 for 4HG generation, where the reflectors used in the setup have been modified where necessary as specified in FIG. 6 for 4HG generation.

FIG. 7 is a schematic view of an optical instrument for supplying light to a sample using an in-line 5^{th} harmonic generation setup with timing compensation. The instrument 300 may be a piece of semiconductor equipment. For example, in order to reduce the size of transistors in semiconductors, it is desirable to use light of smaller wavelengths to improve resolution in photolithography, and instrument 300 may be an equipment used in photolithography, such as a stepper. For discovering tiny defects in semiconductor devices during or after manufacture, it is desirable to use light of smaller wavelengths to improve resolution in anomaly detection, and instrument 300 may be an equipment used in anomaly detection, such as for wafer or reticle inspection. The instrument 300 may also be an optical equipment for measuring properties of samples, such as their thickness, refractive index, critical dimension, height and profile of gratings, such as reflectometers and ellipsometers. Preferably, instrument 300 includes an apparatus such as setup 100 of FIG. 5 or setup 200 of FIG. 6 for generating the 5^{th} harmonic. The instrument 300 may apply the 5^{th} harmonic pulses in a direction normal to the surface of sample 400 along path 302, or along an oblique path 304, as shown in FIG. 7.

While the invention has been described above by reference to various embodiments, it will be understood that changes and modifications may be made without departing from the scope of the invention, which is to be defined only by the appended claims and their equivalent. All references referred to herein are incorporated by reference herein in their entireties.

What is claimed is:

1. A laser light generating apparatus comprising:
a laser source emitting optical pulses at a fundamental wavelength λ₁;
a first nonlinear crystal receiving the optical pulses at fundamental wavelength λ₁ and generates second harmonic optical pulses at a second wavelength λ₂, where λ₂ is substantially equal to half of λ₁;
a second nonlinear crystal receiving the optical pulses at wavelengths λ₁ and λ₂ and generates fourth harmonic optical pulses at wavelength λ₄ where λ₄ is substantially equal to half of λ₂; wherein the first and second nonlinear crystals cause a time delay of the optical pulses at wavelength λ₄ relative to the optical pulses at wavelength λ₁;
a third nonlinear crystal receiving the optical pulses at wavelengths λ₁ and λ₄ to generate a fifth harmonic pulse λ₅, where frequency of the fifth harmonic pulse λ₅ is substantially equal to the sum of the frequencies of the optical pulses at wavelengths λ₁ and λ₄;
optics to focus the optical pulses into each of the first, second and third crystals; and
a birefringent crystal placed in an optical path between the first and second nonlinear crystals, receiving the optical pulses at wavelengths λ₁ and λ₂, wherein the optical pulses at wavelength λ₁ travel at a slower speed in the birefringent crystal than the optical pulses at wavelength λ₂, to compensate for at least a portion of the time delay between the optical pulses at wavelength λ₄ relative to the optical pulses at wavelength λ₁.

2. The apparatus of claim 1, wherein a timing compensating material in the birefringent crystal and optical path length or lengths of the optical pulses at wavelengths λ₁ and λ₂ in the birefringent crystal are such that the optical pulses at wavelengths λ₁ and λ₄ reach the third nonlinear crystal at overlapping times.

3. The apparatus of claim 2, wherein the optical pulses emitted by the laser source have duration shorter than 100 ps.

4. The apparatus of claim 1, wherein a timing compensating material in the birefringent crystal satisfies the relationship ng(λ₁)>ng(λ₂), where ng(λ₁) and ng(λ₂) are the group indices of the material for different polarizations.

5. The apparatus of claim 4, wherein the timing compensating material includes α-BBO or β-BBO.

6. The apparatus of claim 5, wherein the birefringent crystal is negative uniaxial and oriented so that the optical pulses at wavelength λ₁ propagate as an o-ray and the optical pulses at wavelength λ₂ propagate as an e-ray in the negative uniaxial birefringent crystal.

7. The apparatus of claim 1, where the pulse laser source comprises a modelocked Nd:YAG or modelocked Nd:YVO₄ laser.

8. The apparatus of claim 1, where the second nonlinear crystal comprises cesium lithium borate.

9. The apparatus of claim 1, where the third nonlinear crystal comprises cesium lithium borate.

10. The apparatus of claim 1, wherein said optics causes an additional time delay of the optical pulses at wavelengths λ₄ relative to the optical pulses at wavelengths λ₁, and the birefringent crystal compensates for at least a portion of the additional time delay.

11. A method for higher harmonic light generation, comprising:
supplying optical pulses at a fundamental wavelength λ₁ to a first nonlinear crystal so that the first nonlinear crystal generates second harmonic optical pulses at wavelength λ₂, where λ₂ is substantially equal to half of λ₁;
supplying the optical pulses at wavelengths λ₁ and λ₂ to a second nonlinear crystal so that the second nonlinear crystal generates fourth harmonic optical pulses at wavelength λ₄ where λ₄ is substantially equal to half of λ₂; wherein the first and second nonlinear crystals cause a first time delay of the optical pulses at wavelengths λ₄ relative to the optical pulses at wavelengths λ₁; and
causing a second time delay of the optical pulses at wavelengths λ₁ relative to the optical pulses at wavelength λ₂ before the optical pulses at wavelengths λ₁ and λ₂ are supplied to the second nonlinear crystal, so that the second time delay compensates for at least a part of and reduces the first time delay.

12. The method of claim 11, further comprising supplying optical pulses at wavelengths λ₄ and λ₁ to a third nonlinear crystal so that the third nonlinear crystal generates a fifth harmonic pulse λ₅ where frequency of the fifth harmonic pulse λ₅ is substantially equal to the sum of the frequencies of the optical pulses at wavelengths λ₁ and λ₄;

13. The method of claim 12, wherein said causing comprises inserting a birefringent crystal between the first and second nonlinear crystals.

14. The method of claim 13, wherein a timing compensating material in the birefringent crystal and optical path length or lengths of the optical pulses at wavelengths λ₁ and λ₂ in the birefringent crystal are such that the optical pulses at wavelengths λ₁ and λ₄ reach the third nonlinear crystal at overlapping times.

15. The method of claim 14, wherein the optical pulses have duration shorter than 100 ps.

16. An optical instrument for supplying light to a sample, comprising:
a laser source emitting optical pulses at a fundamental wavelength λ₁;
a first nonlinear crystal receiving the optical pulses at fundamental λ₁ and generates second harmonic optical pulses at wavelength λ₂, where λ₂ is substantially equal to half of λ₁;
a second nonlinear crystal receiving the optical pulses at wavelengths λ₁ and λ₂ and generates fourth harmonic optical pulses at wavelength λ₄ where λ₄ is substantially equal to half of λ₂; wherein the first and second nonlinear crystals cause a time delay of the optical pulses at wavelength λ₄ relative to the optical pulses at wavelength λ₁;
a third nonlinear crystal receiving the optical pulses at wavelengths λ₁ and λ₄ to generate a fifth harmonic pulse λ₅, where frequency of the fifth harmonic pulse λ₅ is substantially equal to the sum of the frequencies of the optical pulses at wavelengths λ₁ and λ₄;
optics to focus the optical pulses into each of the first, second and third crystals; and
a birefringent crystal placed in an optical path between the first and second nonlinear crystals, receiving the optical pulses at wavelengths λ₁ and λ₂, wherein the optical pulses at wavelength λ₁ travel at a slower speed in the birefringent crystal than the optical pulses at wavelength λ₂, to compensate for at least a portion of the time delay between the optical pulses at wavelength λ₄ relative to the optical pulses at wavelength λ₁;
wherein the optical pulses at wavelength λ₅ are directed to the sample.
